(19) United States
(12) Patent Application Publication
(10) Pub. No.: US 2013/0052500 A1
(43) Pub. Date: Feb. 28, 2013

(54) PRISMATIC SECONDARY BATTERY

(71) Applicants: Taiki Nonaka, Kakogawa-shi (JP); Toyoki Fujihara, Kanzaki-gun (JP); Toshiyuki Nohma, Kobe-shi (JP)

(72) Inventors: Taiki Nonaka, Kakogawa-shi (JP); Toyoki Fujihara, Kanzaki-gun (JP); Toshiyuki Nohma, Kobe-shi (JP)

(73) Assignee: SANYO ELECTRIC CO., LTD., Osaka (JP)

(21) Appl. No.: 13/597,985

(22) Filed: Aug. 29, 2012

(30) Foreign Application Priority Data
Aug. 31, 2011 (JP) JP2011-189977

(51) Int. Cl. H01M 10/36

(52) U.S. Cl. 429/94

(57) ABSTRACT

A prismatic secondary battery includes a wound electrode assembly, a bottomed prismatic hollow outer body having a mouth and storing the wound electrode assembly, and a sealing plate including a gas release valve and sealing up the mouth. The wound electrode assembly is disposed in the outer body so that the winding axis direction of the wound electrode assembly is parallel to the bottom face of the outer body. A high-melting-point material having a higher melting point than the melting point of a material, constituting the outer body is disposed between both ends of the wound electrode assembly in the winding axis direction and a lateral face of the outer body facing the end of the wound electrode assembly in the winding axis direction.

### TECHNICAL FIELD

The present invention relates to a prismatic secondary battery including a wound electrode assembly.

### BACKGROUND ART

Curbs on emissions of gases causing global warming such as carbon dioxide gas have been strengthened against a background of growing environmental protection movements. To address this, the car industry has been actively developing electric vehicles (EVs) and hybrid electric vehicles (HEVs, PHEVs) in place of automobiles using fossil fuels such as gasoline, diesel oil, and natural gas. Batteries used for such EVs, HEVs, and PHEVs are generally nickel-hydrogen secondary batteries or lithium ion secondary batteries. In recent years, nonaqueous electrolyte secondary batteries such as a lithium ion secondary battery have been widely used because such a battery is lightweight and has high capacity.

Secondary batteries for EVs, HEVs, and PHEVs are required to discharge at high current and high power during, for example, acceleration and hill climbing, and to increase travel distance, and hence a number of batteries are combined in series or parallel to be used as a battery module having high power and large capacity. Prismatic secondary batteries and cylindrical secondary batteries are widely used as secondary batteries used for the battery module.

In the case of a cylindrical secondary battery, the use of especially cylindrical secondary batteries generally used for personal computers and similar devices enables cost reduction in the production of battery modules because these batteries are mass-produced. However, each cylindrical secondary battery has a small capacity. This raises a problem that a considerable number of cylindrical secondary batteries are needed in order to obtain a battery module having a certain power and a certain capacity. In contrast, when a cylindrical secondary battery having an increased power and an increased capacity is used, there is a problem that current collection structures from a positive electrode sheet and a negative electrode sheet are complicated as shown in JP-A-2009-110751.

In order to explain the problem, a current collection structure of a cylindrical secondary battery disclosed in JP-A-2009-110751 will be described with reference to FIG. 6. FIG. 8A is an oblique sectional view of a collector and FIG. 6B Is a schematic sectional view showing the collector and a cylindrical wound electrode assembly before being connected to each other.

The cylindrical secondary battery includes a wound electrode assembly 50 obtained by winding a positive electrode sheet, a negative electrode sheet, and a separator (neither of which are shown in the drawings) so as to locate a positive electrode substrate exposed portion 51 at one end and to locate a negative electrode substrate exposed portion 52 at the other end. A positive electrode collector 53 and a negative electrode collector 54 have annular shapes including through-holes 53a and 54a, respectively, at the centers. Then, the positive electrode collector 53 and the negative electrode collector 54 are disposed on both end faces of the wound electrode assembly 50 so that the through-holes 53a and 54a are connected to a hollow portion 50a in the wound electrode assembly 50.

At this time, the ends of a plurality of substrate exposed portions 51 and 52 of the electrode sheets are sandwiched between a plurality of first protrusions 53b and 54b that are formed on the outer peripheries of the positive electrode collector 53 and the negative electrode collector 54 on the wound electrode assembly 50 site and a plurality of second protrusions 53c and 54c that are similarly formed on inner peripheries, respectively, while not closing the hollow portion 50a in the wound electrode assembly 50. This can suppress the exposure of the positive electrode substrate exposed portion 51 and the negative electrode substrate exposed portion 52 from the positive electrode collector 53 and the negative electrode collector 54, respectively, and enables the positioning of the positive electrode collector 53 and the negative electrode collector 54 with respect to the end faces of the wound electrode assembly 50. In this state, energy is applied to the peripheral surfaces opposite to principal surfaces 53d and 54d of the positive electrode collector 53 and the negative electrode collector 54 to melt the positive electrode collector 53 and the negative electrode collector 54, thereby welding the positive electrode collector 53 and the negative electrode collector 54 to the end faces of the positive electrode substrate exposed portion 51 and the negative electrode substrate exposed portion 52, respectively.

Such a structure can suppress spattered particles entering the wound electrode assembly 50 by the first protrusions 53b and 54b formed on the positive electrode collector 53 and the negative electrode collector 54, respectively, even when the particles are spattered on the positive electrode collector 53 and the negative electrode collector 54 during welding, and enables strong joints of the positive electrode collector 53 and the negative electrode collector 54 to the wound electrode assembly 50. However, the positive electrode collector 53 and the negative electrode collector 54 have complicated structures, thereby complicating the processing.

in contrast, prismatic secondary batteries have an advantage that the capacity of the prismatic secondary batteries can be readily increased, thereby reducing the number of the prismatic secondary batteries used for providing a battery module having a certain power and a certain capacity, but have a disadvantage in that these batteries are more expensive than generally used cylindrical secondary batteries. Both the cylindrical secondary battery and the prismatic secondary battery that are used for forming a battery module have the advantages and the disadvantages as described above, and various improvements have been carried out in order to solve the disadvantages and to further develop the advantages.

Moreover, secondary batteries for EVs, HEVs, and PHEVs that are required to have high, power and large capacity include various safety measures such as a gas release valve for releasing gas in the battery to the outside when the battery internal pressure is increased. For example, JP-A-2007-194167 discloses a cylindrical secondary battery including a terminal equipped with a gas release valve, and JP-A-2003-187774 discloses a prismatic secondary battery including a sealing plate equipped with a gas release valve.

Typically, gas generated in a battery using a wound electrode assembly moves along the winding axis through a predetermined passage and brings the gas release valve into operation to release the gas to the outside. This phenomenon similarly occurs even in cylindrical secondary batteries and in prismatic secondary batteries. Secondary batteries for EVs, HEVs, and PHEVs include not only gas release valves as disclosed in JP-A-2007-194167 and JP-A-2003-187774 but also various safety measures, and therefore can ensure enough safety in a normal use condition.

In nonaqueous electrolyte secondary batteries widely used as secondary batteries for EVs, HEVs, and PHEVs, aluminum or an aluminum alloy, which is the same material as that of a substrate of the positive electrode sheet is typically used for an outer body. Aluminum or aluminum alloy has a lower melting temperature than that of copper or a copper alloy that is a material of a substrate of the negative electrode sheet.

A severe forced internal short circuit test such as a nail penetration test may lead a battery to thermal runaway and a high temperature gas may be rapidly generated in large amounts in the battery. The high temperature gas generated in the battery moves along the winding axis of the wound electrode assembly to be discharged out from the inside of the wound electrode assembly. When the high temperature gas is discharged out toward the outer body before the gas reaches the gas release valve through a predetermined passage, the outer body having a low melting temperature may be melted before the gas release valve works and the high temperature gas may be exhausted in any direction different from the intended direction.

The phenomenon is more likely to occur the larger the capacity of the battery, and is likely to occur especially in a prismatic secondary battery in which a wound electrode assembly is disposed in a bottomed prismatic hollow outer body so that the winding axis direction of the wound electrode assembly is parallel to the bottom face of the outer body. However, a cylindrical secondary battery as disclosed in JP-A-2009-110751 is unlikely to cause such a phenomenon because both ends of the wound electrode assembly are closed by the collectors. Also in a prismatic secondary battery in which positive electrode sheets and negative electrode sheets are stacked to each other with separators interposed therebetween, such a phenomenon is unlikely to occur because the high temperature gas generated in the battery flows in various directions along the electrode sheets.

### SUMMARY

An advantage of some aspects of the invention is to provide a prismatic secondary battery that includes a wound electrode assembly disposed in a bottomed prismatic hollow outer body so that the winding axis direction of the wound electrode assembly is parallel to the bottom face of the outer body, and in which a high temperature gas can be exhausted to the outside through a predetermined passage even when a high-temperature gas is generated due to some fault in the battery.

According to an aspect of the invention, a prismatic secondary battery includes a wound electrode assembly formed by winding a positive electrode sheet and a negative electrode sheet with a separator interposed therebetween, a bottomed prismatic hollow outer body having a mouth and storing the wound electrode assembly, and a sealing plate including a gas release valve and sealing up the mouth. In the prismatic secondary battery, the wound electrode assembly is disposed in the outer body so that the winding axis direction of the wound electrode assembly is parallel to the bottom face of the outer body, and a high-melting-point material having a higher melting point than the melting point of a material constituting the outer body is disposed between at least one of either ends of the wound electrode assembly in the winding axis direction and a lateral face of the outer body facing the end of the wound electrode assembly in the winding axis direction.

In the prismatic secondary battery of the invention, even when any factor leads to thermal runaway of the battery, a high temperature gas is rapidly generated in large amounts in the battery, and the high temperature gas is discharged out from an end of the wound electrode assembly, the high temperature gas is discharged out toward the high-melting-point material having a higher melting point than the melting point of a material constituting the outer body. Thus, in the prismatic secondary battery of the invention, the high temperature gas generated in the battery can be exhausted from the gas release valve provided on the sealing plate through a predetermined passage and hence is not exhausted in any direction different from the intended direction. Therefore, a plurality of such prismatic secondary batteries can be combined to form a module that ensures reliability.

In the prismatic secondary battery of the invention, the high-melting-point materials are not necessarily disposed on both ends of the wound electrode assembly, and the high-melting-point material disposed on at least one end can provide a certain advantage of the invention. However, the high-melting-point materials are preferably disposed on both ends so that the reliability can be further improved.

In the prismatic secondary battery of the invention, it is preferable that the high-melting-point material cover an area of 100% or more of a lateral face perpendicular to the winding axis direction of the wound electrode assembly in the outer body.

When a high temperature gas is directly discharged toward areas without the high-melting-point material, the outer body is likely to be melted starting from these areas. In the prismatic secondary battery of the invention, the high-melting-point material covers the whole lateral face perpendicular to the winding axis direction of the wound electrode assembly and further covers a larger area. Thus, a high temperature gas is not directly discharged toward areas without the high-melting-point material, thereby reducing the possibility of melting the outer body. Therefore, a prismatic secondary battery with much higher reliability can be obtained.

In the prismatic secondary battery of the invention, it is preferable that the high-melting-point material be a plate, have an larger area than a section area perpendicular to the winding axis direction of the wound electrode assembly, and have a smaller area than the area of the lateral face of the outer body facing the high-melting-point material.

In the prismatic secondary battery of the invention, the plate made of the high-melting-point material can sufficiently cover the end face of the electrode assembly, thereby suitably providing the advantages of the invention. The plate that is separated from the outer body can be readily disposed in a required area, and consequently the prismatic secondary battery can be readily assembled.

In the prismatic secondary battery of the invention, it is preferable that the outer body have no polarity.

Secondary batteries used for vehicles such as EVs, HEVs, and PHEVs are required to have long-term durability. An outer body having polarity may become corroded during prolonged use of the outer body and may reduce the durability. In the prismatic secondary battery of the invention in which the outer body has no polarity, a prismatic secondary battery having excellent long-term durability and having high long-term reliability can be obtained.

In the prismatic secondary battery of the invention, it is preferable that the wound electrode assembly include a stacked positive electrode substrate exposed portion on one end in the winding axis direction and include a stacked negative electrode substrate exposed portion on the other end in the winding axis direction, a positive electrode collector be connected to an outermost surface of the stacked positive electrode substrate exposed portion in the stacking direction, and a negative electrode collector be connected to an outermost surface of the stacked negative electrode substrate exposed portion in the stacking direction.

When both the positive electrode collector and the negative electrode collector are connected to a position different from the outermost surface of each stacked substrate exposed portion in the stacking direction, both the positive electrode collector and the negative electrode collector are connected to cover the end face of the stacked substrate exposed portion. Such a structure does not cause the problem of the invention and there is no technical importance by adopting the structure of the invention.

In the prismatic secondary battery of the invention, it is preferable that the bottomed prismatic hollow outer body be formed of aluminum or an aluminum alloy and that the high-melting-point material to be used have a melting point of 700° C. or higher.

Aluminum and an aluminum alloy have a melting point of about 650° C. Hence, a battery that Includes the high-melting-point material having a melting point of 700° C. or higher suitably provides the advantages of the invention.

In the prismatic secondary battery of the invention, the high-melting-point material may be one material selected from silicon dioxide, zirconia, alumina, titania, silicon carbide, silicon nitride, and boron nitride.

These materials are ceramic materials having higher melting points than those of aluminum and an aluminum alloy and are substantially Insulating materials to be unlikely to affect electrode reaction, thereby suitably providing the advantages of the invention.

In the prismatic secondary battery of the invention, the high-melting-point, material may be one material selected from scandium, titanium, vanadium, chromium, manganese, iron, cobalt, nickel, copper, yttrium, zirconium, niobium, molybdenum, ruthenium, rhodium, palladium, silver, hafnium, tantalum, tungsten, rhenium, osmium, iridium, platinum, gold, a titanium alloy, a stainless steel, a nickel alloy, a copper alloy, silicon, and carbon fiber. When such a high-melting-point material is used, it is preferable that the high-melting-point material be electrically insulated from the positive electrode sheet and the negative electrode sheet.

These materials are substantially electrically conductive materials but have higher melting points than those of aluminum and an aluminum alloy, thereby providing the advantages of the invention to some extent. For example, when the high-melting-point material is electrically connected to the positive electrode, electropositive potential of the positive electrode causes, for example, the elution of the high-melting-point material or the decomposition of an electrolyte component, resulting in the reduction in the safety and reliability of the battery. When the high-melting-point material is electrically connected to the negative electrode, a material that readily forms an alloy with lithium forms the alloy with lithium and this may reduce the battery reliability or cycling characteristics. When the high-melting-point material used in the invention is electrically insulated from the positive electrode sheet and the negative electrode sheet, the high-melting-point material does not contribute the electrode reaction as mentioned above, thereby suitably providing the advantages of the invention.

In the prismatic secondary battery of the invention, when the high-melting-point material is electrically conductive, it is preferable that an insulating sheet be disposed between the wound electrode assembly and the outer body, and that the high-melting-point material be disposed between the outer body and the insulating sheet.

The prismatic secondary battery of the invention enables the insulation of an electrically conductive high-melting-point material concurrently with the improvement, of electrical insulation properties between the wound electrode assembly and the outer body, thereby affording a prismatic secondary battery having higher reliability.

In the prismatic secondary battery of the invention, it is preferable that the high-melting-point material have a thickness of from 0.05 mm to 0.5 mm.

The appropriate thickness of the high-melting-point material varies depending on its specific heat and melting point. When the high-melting-point material has a thickness of less than 0.05 mm, the thickness of the high-melting-point material is so small that heat of a high temperature gas generated in the battery will be directly conducted to the outer body, and thus the advantages of the invention will be unlikely to be provided. A high-melting-point material having a thickness of more than 0.5 mm is not preferred because such a high-melting-point material reduces the volume of the wound electrode assembly in proportion to the thickness resulting in the reduction of the battery energy density.

In the prismatic secondary battery of the invention, it is preferable that the prismatic secondary battery have a battery capacity of 20 Ah or more.

When a severe forced internal short circuit test such as a nail penetration test is carried out without the high-melting-point material of the invention, melting of a lateral face is not substantially observed in a prismatic secondary battery having a small battery capacity. A prismatic secondary battery having a larger capacity is likely to cause the melting, and a prismatic secondary battery especially having a high capacity of 20 Ah or more causes the melting. Thus, the invention is applied to a prismatic secondary battery having a battery capacity of 20 Ah or more to increase the technical importance.

In the prismatic secondary battery of the invention, it is preferable that at least one of the positive electrode substrate exposed portion and the negative electrode substrate exposed portion be divided into two portions, that an intermediate member made of a resin material and having at least one conductive intermediate member be disposed between the two portions, that the collector close to the bisectional substrate exposed portion be disposed on at least one side of an outermost surface of the bisectional substrate exposed portion, and that the collector be electrically connected to the bisectional substrate exposed portion together with at least one conductive intermediate member of the intermediate member by resistance welding.

In a prismatic secondary battery having a large battery capacity of 20 Ah or more, a number of positive electrode substrate exposed portions and negative electrode substrate exposed portions are stacked to increase the thickness of each electrode substrate exposed portion after stacking. In the prismatic secondary battery of the invention, even when the stacked positive electrode substrate exposed portion or the stacked negative electrode substrate exposed portion has a large thickness, the bisectional substrate exposed portion, the conductive intermediate member, and the collector can be simultaneously welded by series resistance welding. In addition, when a plurality of such conductive intermediate members are provided, the conductive intermediate members are held by and fixed to the intermediate member made of a resin material. This improves the dimensional precision between the plurality of conductive intermediate members and enables stable positioning of the plurality of conductive Intermediate members between the bisectional substrate exposed portions. As a result, the resistance-welded part obtains improved quality and a low resistivity can be achieved. Therefore, with the prismatic secondary battery of the invention, a prismatic secondary battery having improved output power and reduced variation in the output power can be obtained.

### BRIEF DESCRIPTION OP THE DRAWINGS

The invention will be described with reference to the accompanying drawings, wherein like numbers reference like elements.

FIG. 1 is a partial development view showing the positional relation of electrode sheets and a separator when a wound electrode assembly of a prismatic nonaqueous electrolyte secondary battery of an embodiment is prepared.

FIG. 2 is a schematic exploded perspective view showing the prismatic nonaqueous electrolyte secondary battery of the embodiment without collectors, etc.

FIG. 3A is a sectional view of the nonaqueous electrolyte secondary battery of the embodiment and FIG. 3B is a sectional view taken along the line IIIB-IIIB in FIG. 3A.

FIG. 4 is a sectional view taken along the line IV-IV in FIG. 3.

FIG. 5 is a side sectional view showing the resistance welding state between a substrate exposed portion and a collector in the embodiment.

FIG. 8A is an oblique sectional view of a related-art collector and FIG. 6B is a schematic sectional view showing the related-art collector and a cylindrical wound electrode assembly before connecting to each other.

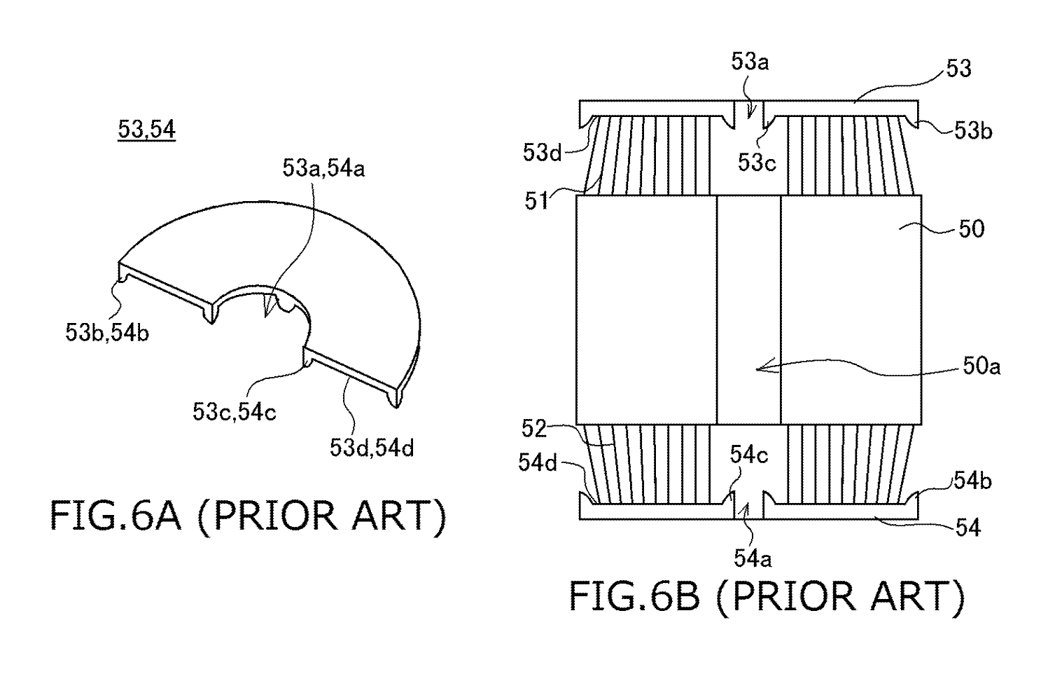

### DESCRIPTION OF EXEMPLARY EMBODIMENTS

Embodiments of the invention will now be described in detail with reference to drawings. However, the embodiments below are intended to exemplify the technical spirit of the invention, the invention is not intended to be limited to the embodiments, and the invention may equally be applied to various modified cases without departing from the technical spirit described in the claims. In each drawing used for explanation in the specification, each member is appropriately shown on a different scale so that the member has a recognizable size in each drawing and the members are not necessarily shown in proportion to the actual sizes.

### Embodiment

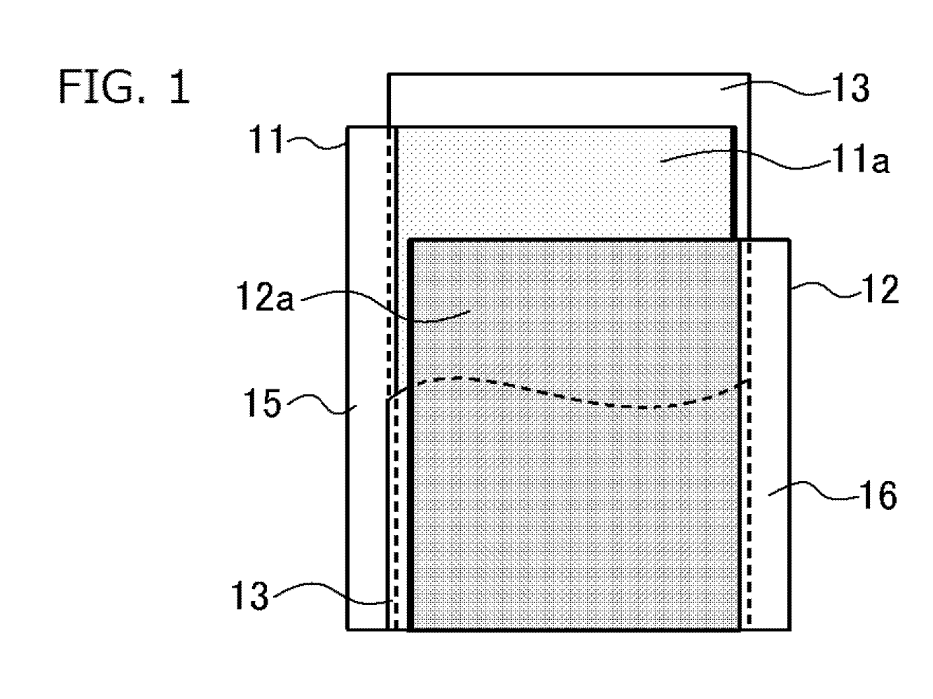

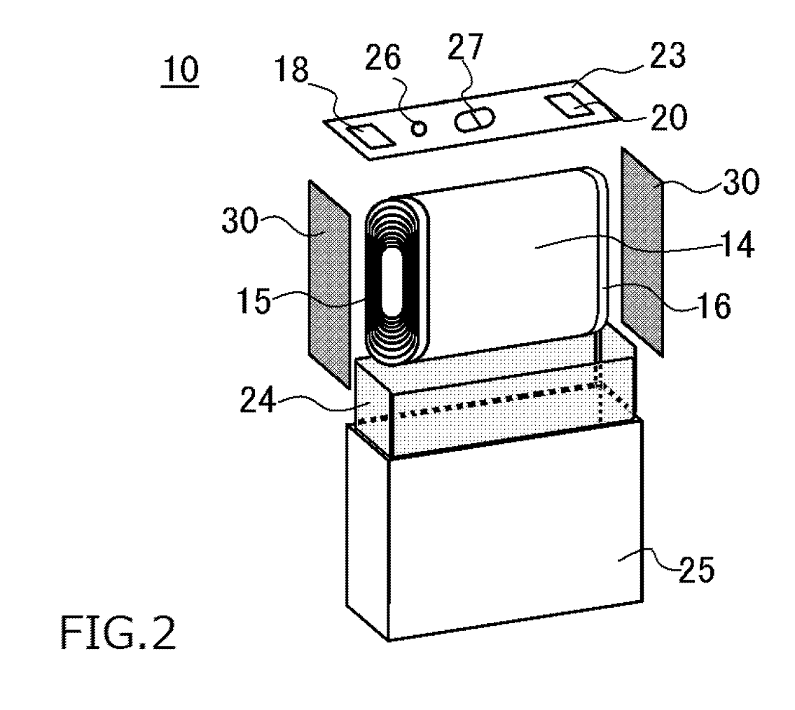

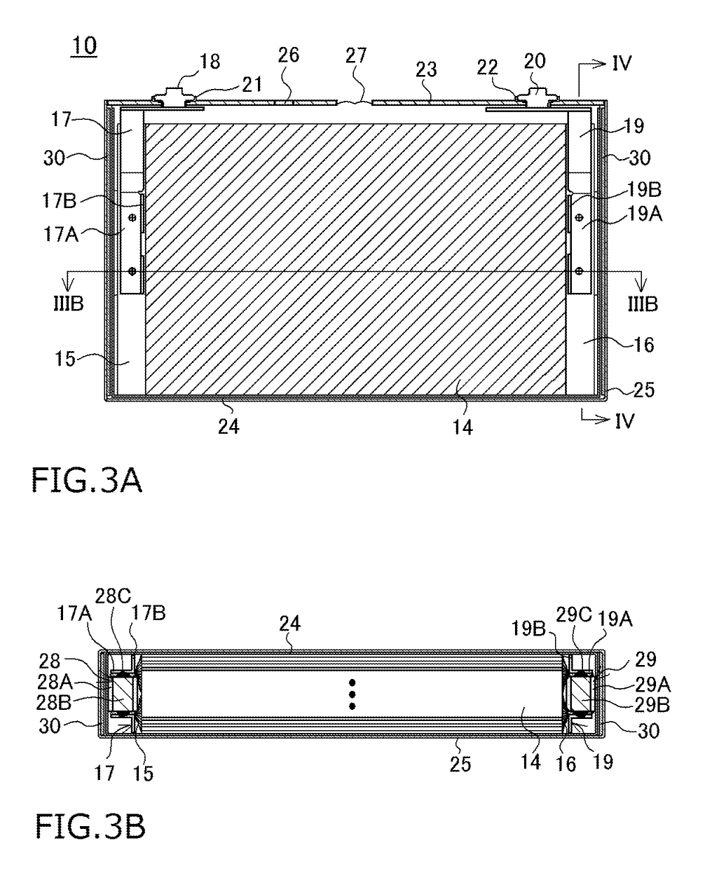

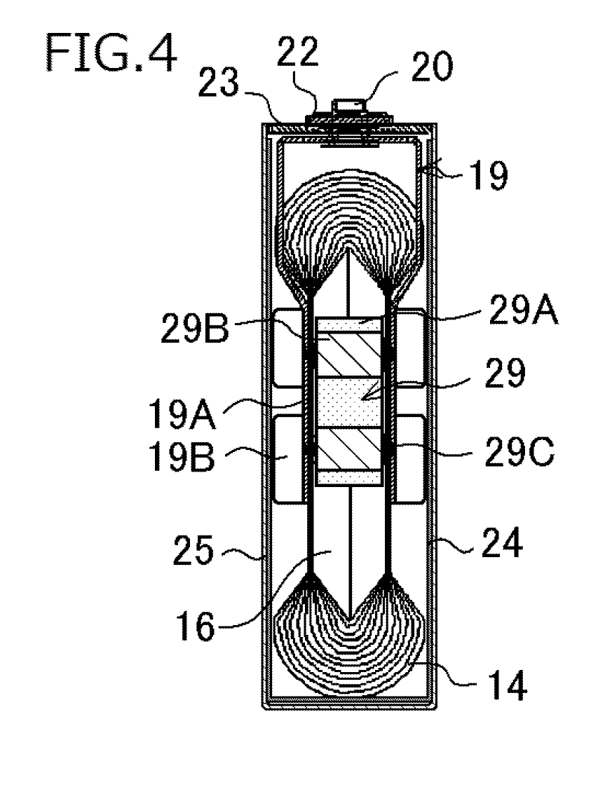

Firstly, as an example of a prismatic secondary battery of the embodiment, a prismatic nonaqueous electrolyte secondary battery will be described with reference to FIG. 1 to FIG. 4. FIG. 1 is a partial development view showing the positional relation of electrode sheets and a separator when a wound electrode assembly of the prismatic nonaqueous electrolyte secondary battery is prepared. FIG. 2 is a schematic exploded perspective view showing the prismatic nonaqueous electrolyte secondary battery without collectors and similar components. FIG. 3A is a sectional view of the nonaqueous electrolyte secondary battery of the embodiment and FIG. 3B is a sectional view taken along the line IIIB-IIIB in FIG. 3 A. FIG. 4 is a sectional view taken along the line IV-IV in FIG. 3.

The prismatic nonaqueous electrolyte secondary battery 10 includes a flat wound electrode assembly 14 in which a positive electrode sheet 11 and a negative electrode sheet 12 are wound with a separator 13 interposed therebetween. The positive electrode sheet 11 is prepared by coating both faces of a positive electrode substrate made of aluminum foil with a positive electrode active material mixture 11a, then drying and rolling the coated substrate, and slitting the substrate so as to expose the aluminum foil in a strip shape. The negative electrode sheet 12 is prepared by coating both faces of a negative electrode substrate made of copper foil with a negative electrode active material mixture 12a, then drying and rolling the coated substrate, and slitting the substrate so as to expose the copper foil In a strip shape.

Then, the positive electrode sheet 11 and the negative electrode sheet 12 obtained as mentioned above are stacked with a microporous polyolefin separator 13 interposed therebetween so as to displace the aluminum foil exposed portion of the positive electrode sheet 11 and the copper foil exposed portion of the negative electrode sheet 12 from the counter electrode active material mixtures 12a and 11a, respectively. Subsequently, the whole is wound to prepare the flat wound electrode assembly 14 including a plurality of stacked positive electrode substrate exposed portions 15 on one end in the winding axis direction and including a plurality of stacked negative electrode substrate exposed portions 18 on the other end.

The plurality of stacked positive electrode substrate exposed portions 15 are connected to a positive electrode terminal 18 with a positive electrode collector 17 interposed therebetween, and similarly, the plurality of stacked negative electrode substrate exposed portions 16 are connected to a negative electrode terminal 20 with a negative electrode collector 19 interposed therebetween. In the exemplified case, the positive electrode collector 17 and the negative electrode collector 19 are directly connected to the positive electrode terminal 18 and the negative electrode terminal 20, respectively. However, the positive electrode collector 17 and the negative electrode collector 19 may be connected to the positive electrode terminal 18 and the negative electrode terminal 20 with respective additional conductive members interposed therebetween.

The positive electrode terminal 18 and the negative electrode terminal 20 are fixed to a sealing plate 23 with insulating members 21 and 22 interposed therebetween, respectively. The prismatic nonaqueous electrolyte secondary battery 10 of the embodiment is produced by inserting the flat wound electrode assembly 14 prepared as mentioned above into a prismatic outer body 25 with a resin insulating sheet 24 standing therebetween except the sealing plate 23 side, then laser-welding the sealing plate 23 to a mouth portion of the outer body 25, then pouring a nonaqueous electrolytic solution from an electrolyte pour hole 26, and sealing up the electrolyte pour hole 26. The sealing plate 23 includes a gas release valve 27 as a safety measure.

In the positive electrode sheet 11 site in the flat wound electrode assembly 14, the plurality of stacked positive electrode substrate exposed portions 15 are divided into two portions and a positive electrode intermediate member 28 is disposed between the two portions (see FIG. 3B). The positive electrode intermediate member 28 includes an insulating intermediate member 28A made of a resin material and a plurality of conductive intermediate members 28B, two conductive intermediate members 28B in the embodiment, disposed on the insulating intermediate member 28A. Each of the conductive intermediate members 28B includes a protrusion 28C in a truncated cone shape working as a projection on each side facing the stacked positive electrode substrate exposed portion 15.

In a similar manner, the plurality of stacked negative electrode substrate exposed portions 18 are divided into two portions at the negative electrode sheet 12 site, and a negative electrode intermediate member 29 is disposed between the two portions (see FIG. 3B and FIG. 4). The negative electrode intermediate member 29 includes an insulating intermediate member 29A made of a resin material and a plurality of conductive intermediate members 29B, two conductive intermediate members 29B in the embodiment, disposed on the insulating intermediate member 29A. Each of the conductive intermediate members 29B Includes a protrusion 29C in a truncated cone shape functioning as a projection on each side facing the stacked negative electrode substrate exposed portion 16.

The positive electrode collector 17 is disposed on the outermost surface of the positive electrode substrate exposed portion 15 positioned on each side of the positive electrode intermediate member 28. The negative electrode collector 19 is disposed on the outermost surface of the negative electrode substrate exposed portion 16 positioned on each side of the negative electrode intermediate member 29.

The conductive intermediate member 28B constituting the positive electrode intermediate member 28 is made of aluminum, which is the same material as that of the positive electrode substrate. The conductive intermediate member 29B constituting the negative electrode intermediate member 29 is made of copper, which is the same material as that of the negative electrode substrate. The shape of the conductive intermediate member 28B may be the same as or different from that of the conductive intermediate member 29B. Examples of the material usable as the insulating intermediate member 28A constituting the positive electrode intermediate member 28 and as the insulating intermediate member 29A constituting the negative electrode intermediate member 29 include polypropylene (PP), polyethylene (PE), polyvinylidene chloride (PVDC), polyacetal (POM), polyamide (PA), polycarbonate (PC), and polyphenylene sulfide (PPS).

In the prismatic nonaqueous electrolyte secondary battery 10 of the embodiment, the exemplified positive electrode intermediate member 28 and the exemplified negative electrode intermediate member 29 include insulating intermediate members 28A and 29A made of a resin material and having two conductive intermediate members 28B and 20B, respectively. However, the conductive intermediate members 28B and 29B may be used as one pair or three pairs depending on a required battery output power, etc. When two or more pairs are used, both the insulating intermediate members 28A and 29A made of a resin material hold two or more conductive intermediate members 28B or 29B. Therefore, each pair of the conductive intermediate members 28B and 29B can be stably positioned and disposed between the bisectional substrate exposed portions.

The positive electrode collector 17 is resistance-welded to the outermost surface of the bisectional positive electrode substrate exposed portion 15, the positive electrode substrate exposed portions 15 are resistance-welded to each other, and the conductive intermediate member 28B of the positive electrode intermediate member 28 is resistance-welded to the inner surface of the bisectional positive electrode substrate exposed portion 15. Similarly, the negative electrode collector 19 is resistance-welded to the outermost surface of the bisectional negative electrode substrate exposed portion 18, the negative electrode substrate exposed portions 16 are resistance-welded to each other, and the conductive intermediate member 29B constituting the negative electrode intermediate member 29 is resistance-welded to the inner surface of the bisectional negative electrode substrate exposed portion 16.

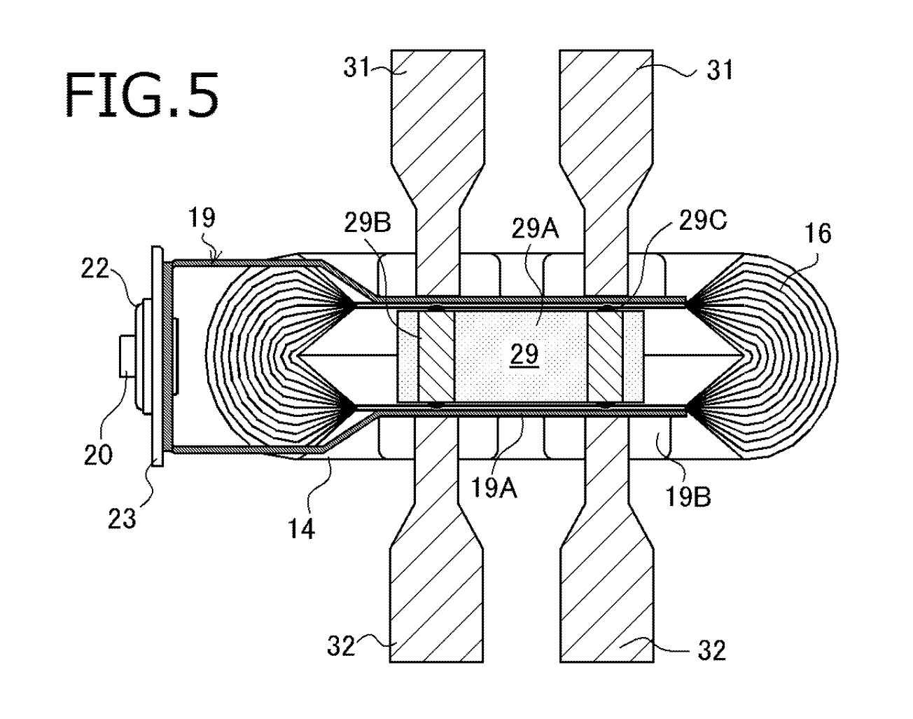

The following will now be described in detail with reference to FIG. 5: a specific method for producing the flat wound electrode assembly 14, the resistance welding method using the positive electrode substrate exposed portion 15, the positive electrode collector 17, and the positive electrode intermediate member 28 having the conductive intermediate member 28B, and the resistance welding method using the negative electrode substrate exposed portion 18, the negative electrode collector 19, and the negative electrode intermediate member 29 having the conductive intermediate member 29B. FIG. 5 is a side sectional view showing the resistance welding state between, the substrate exposed portion, and the collector in the embodiment. In the embodiment, the shape of the positive electrode intermediate member 28 may be substantially the same as the shape of the negative electrode intermediate member 29, and both resistance welding methods are substantially the same. Therefore, the method for the negative electrode sheet 12 site will be described below as a typical example,

First, as shown in FIG. 1, the positive electrode sheet 11 and the negative electrode sheet 12 were stacked with the microporous polyolefin separator 13 interposed therebetween so as to displace the positive electrode substrate (aluminum foil) exposed portion 15 of the positive electrode sheet 11 and the negative electrode substrate (copper foil) exposed portion 16 of the negative electrode sheet 12 from the counter electrode active material mixtures 12a and 11a, respectively, and the whole was wound to prepare the flat wound electrode assembly 14. Then, the negative electrode substrate exposed portion 16 was divided from the wound center to both sides into two portions, and the bisectional negative electrode substrate exposed portion 16 was bundled to a center as a quarter of the thickness of the electrode assembly. Here, the bundled copper foil had a thickness of about 350 μm per side and had a total stacking number of 44 per side (88 for both sides).

The negative electrode collector 19 was prepared by punching out and bending a copper plate having a thickness of 0.6 mm, etc. The negative electrode collector 19 may be prepared by, for example, casting of a copper plate. The negative electrode collector 19 used here includes a main body 19A extending from a resistance-welding position to the negative electrode terminal 20 and a rib 19B extending from the welding position of the main body 19A in an approximately perpendicular direction and is integrally formed so as to have a symmetric structure with respect to the negative electrode terminal 20.

Then, the negative electrode collector 19 is disposed on each outermost surface of the bisectional negative electrode substrate exposed portion 18. The negative electrode intermediate member 29 is inserted between the inner surfaces of the bisectional negative electrode substrate exposed portion 16 so as to bring the truncated-cone-shaped protrusions 29C on both sides of the conductive intermediate member 29B into contact with the respective inner surfaces of the bisectional negative electrode substrate exposed portion 16. The conductive intermediate member 29B of the negative electrode intermediate member 29 has, for example, a column shape and includes both ends with the truncated-cone-shaped protrusions 29C. An opening may be formed in each truncated-cone-shaped protrusion 29C in order to concentrate current onto the periphery of the truncated-cone-shaped protrusion 29C during resistance welding, thereby forming a fine weld mark (nugget). The truncated-cone-shaped protrusion 29C may have substantially the same height as that of a protrusion (projection) generally formed on a resistance welding member, in other words, may have a height of several millimeters.

The diameter and the length of the conductive intermediate member 29B constituting the negative electrode intermediate member 29 vary depending on the sizes of the flat wound electrode assembly 14 and the outer body 25 (see FIG. 2 and FIG. 3) and may be about 3 mm to several tens of millimeters. The conductive intermediate member 29B constituting the negative electrode Intermediate member 29 has been exemplified to have a column shape in the embodiment, but may have any shape, for example, a prismatic shape and an elliptical column shape, as long as it is a metal block.

In the negative electrode intermediate member 29 of the embodiment, each of two conductive intermediate members 29B is integrally held with the insulating intermediate member 29A made of a resin material. In this case, the conductive intermediate members 29B are held so as to be parallel to each other and are disposed so that each end face of the conductive intermediate member 29B, that is, each face with the truncated-cone-shaped protrusion 29C, is positioned on the inner surface of the bisectional negative electrode substrate exposed portion 16. The insulating intermediate member 29A made of a resin material constituting the negative electrode intermediate member 29 may have any shape, for example, a prismatic shape and a column shape. However, in the embodiment, the shape is a prismatic shape for stable positioning and fixing between the bisectional negative electrode substrate exposed portions 16.

The length of the negative electrode intermediate member 29 varies depending on the size of the prismatic nonaqueous electrolyte secondary battery but may be 20 mm to several tens of millimeters. The width is preferably designed so that, around the negative electrode intermediate member 29, the side faces of the insulating intermediate member 29A made of a resin material will be in contact with the inner surface of the bisectional negative electrode substrate exposed portion 16 after resistance welding. In other regions, for example, a groove may be formed on a peripheral part of the negative electrode intermediate member 29 or a cavity may be formed inside the negative electrode intermediate member 29 for good degassing during resistance welding.

Next, as shown in FIG. 5, the flat wound electrode assembly 14 is disposed between a pair of resistance welding electrode rods 31 and 32 disposed above and below. Additionally, the negative electrode collector 19 is disposed so that each main body 19A at a position of the rib 19B faces the truncated-cone-shaped protrusion 29C formed on each side of the conductive intermediate member 29B across the bisectional negative electrode substrate exposed portion 16. Both pairs of resistance welding electrode rods 31 and 32 are brought into contact with the main body 19A of the negative electrode collector 19.

The negative electrode collector 19 may be disposed on each outermost surface of the negative electrode substrate exposed portion 16 before or after disposing the negative electrode intermediate member 29 between the bisectional negative electrode substrate exposed portions 16. The negative electrode collector 19 may be connected to the negative electrode terminal 20 before or after resistance-welding the negative electrode collector 19 to the negative electrode substrate exposed portion 16. However, previous connection of the negative electrode collector 19 to the negative electrode terminal 20 followed by resistance welding of the negative electrode collector 19 to the negative electrode substrate exposed portion 16 leads to easy positioning during resistance welding to improve production efficiency.

Then, an appropriate pressure is applied between the pair of resistance welding electrode rods 31 and 32, followed by resistance welding in a predetermined, condition. A resistance-welding current flows, for example, in the following order: the resistance welding electrode rod 31, the upper main body 19A of the negative electrode collector 19, the bisectional negative electrode substrate exposed portion 16, the conductive intermediate member 29B, the bisectional negative electrode substrate exposed portion 16, the lower main body 19A of the negative electrode collector 19, to the resistance welding electrode rod 32. This forms the resistance-welded parts between the upper main body 19A of the negative electrode collector 19, the bisectional negative electrode substrate exposed portion 18, and one end face of the conductive intermediate member 29B and between the other end face of the conductive intermediate member 29B, the bisectional negative electrode substrate exposed portion 16, and the lower main body 19A of the negative electrode collector 19.

At this time, the negative electrode collector 19 having a symmetric structure with respect, to the negative electrode terminal 20 leads to a short circuit from the upper main body 19A to the lower main body 19A, and reactive current flows. However, a large resistance-welding current can achieve effective resistance welding by maintaining an appropriate pressure between the pair of resistance welding electrode rods 31 and 32. Moreover, the negative electrode intermediate member 29 is disposed between the bisectional negative electrode substrate exposed portions 16 while being stably positioned during the resistance welding. This enables resistance welding in an exact and stable condition, and can suppress variation in the welding strength, thereby achieving low resistivity of the welded part. Therefore, a prismatic nonaqueous electrolyte secondary battery capable of high-current charging and discharging can be produced.

In the exemplified embodiment, the conductive intermediate member 29B constituting the negative electrode intermediate member 29 includes both ends on which the truncated-cone-shaped protrusions 29C are formed. However, the truncated-cone-shaped protrusion 29C is not a necessary component and may not be formed. In the exemplified embodiment, the truncated-cone-shaped protrusion 29C is formed. However, the protrusion may have a truncated triangular pyramid shape, a truncated square pyramid shape, and a truncated multiangular pyramid. Moreover, an opening (hole) may be formed at the leading end of the protrusion. A protrusion with no opening works in a similar manner to a related-art projection method during resistance welding. When the protrusion has an opening on the leading end side, current is concentrated around the opening during resistance welding to improve a heat generating condition, thereby achieving better resistance welding.

In this manner, the wound electrode assembly 14 to be used in the prismatic nonaqueous electrolyte secondary battery 10 of the embodiment can be prepared. The wound electrode assembly 14 includes the stacked positive electrode substrate exposed portion 15 on one end in the winding axis direction and includes the stacked negative electrode substrate exposed portion 16 on the other end in the winding axis direction. The positive electrode collector 17 is connected to the outermost surface of the stacked positive electrode substrate exposed portion 15 in the stacking direction by welding, and the negative electrode collector 19 is connected to the outermost surface of the stacked negative electrode substrate exposed portion 16 in the stacking direction by welding.

In the prismatic nonaqueous electrolyte secondary battery 10 of the embodiment, similar to the positive electrode sheet 11 site similar to the case of the negative electrode sheet 12 site, a positive electrode intermediate member 28 including an insulating intermediate member 28A, a conductive Intermediate member 28B, and a truncated-cone-shaped protrusion 28C is disposed on the inner side of the bisectional positive electrode substrate exposed portion 15, and a positive electrode collector 17 including main bodies 17A and ribs 17B is disposed on the outermost surfaces of the positive electrode substrate exposed portion 15, followed by resistance welding, as an example.

The ribs 17B and 19B formed on the positive electrode collector 17 and the negative electrode collector 19 are integrally formed with the main bodies 17A and 19A, respectively, and are formed by substantially perpendicularly bending parts of the positive electrode collector 17 and the negative electrode collector 19 at the boundaries with the main bodies 17A and 19A, respectively. The bending angle is not necessarily exactly perpendicular and may be substantially near perpendicular by about 10°. Both the ribs 17B and 19B provide an advantage for suppressing the dispersion of particles spattered from between the resistance welding electrode rod 31 or 32 and the main body 17A of the positive electrode collector 17 or the main body 19A of the negative electrode collector 19 toward the flat wound electrode assembly 14 during resistance welding. Both the ribs 17B and 19B also provide an advantage as radiation fins in order to suppress melting of areas except the resistance welding areas of the positive electrode collector 17 and the negative electrode collector 19,

In addition, the formation of the ribs 17B and 19B to slightly protrude from the wound electrode assembly 14 to the outer body 25 side (outer side) increases the advantage for suppressing the dispersion of particles spattered from between the resistance welding electrode rod 31 or 32 and the main body 17A of the positive electrode collector 17 or the main body 19A of the negative electrode collector 19 toward the flat wound electrode assembly 14 during resistance welding. The formation in such a manner also brings the ribs 17B and 19B into indirect contact with the outer body 25 with the insulating sheet 24 interposed therebetween as shown In FIG. 3B, thereby suppressing the movement of the flat wound electrode assembly 14 in the outer body 25.

In the exemplified embodiment, the positive electrode intermediate member 28 and the negative electrode Intermediate member 29 are disposed between the bisectional positive electrode substrate exposed portions 15 and between the negative electrode substrate exposed portions 16, respectively. However, the positive electrode intermediate member 28 and the negative electrode intermediate member 29 are not necessary components. Either may be provided on one of the positive electrode substrate exposed portion 15 and the negative electrode substrate exposed portion 16. Moreover, without the positive electrode intermediate member 28 or the negative electrode Intermediate member 29, in other words, without the positive electrode substrate exposed portion 15 or the negative electrode substrate exposed portion 16 divided into two portions, the positive electrode collector 17 and the negative electrode collector 19 may be attached to the respective electrode substrate exposed portions by resistance welding. However, the advantageous effect, of the invention is more effectively provided when a prismatic secondary battery has a larger capacity such as, for example, a capacity of 20 Ah or more. Hence, for obtaining a high power prismatic secondary battery with a reduced battery internal resistance, the structure as described in the embodiment is preferably adopted.

Then, the periphery of the flat, wound electrode assembly 14 attached with the positive electrode collector 17 and the negative electrode collector 19 as described above is covered with the insulating sheet 24. Next, in the prismatic outer body 25 made of aluminum or an aluminum alloy, as shown in FIG. 2 to FIG. 4, plates of a high-melting-point material 30 having a melting point higher than the melting point of aluminum or an aluminum alloy (about 650° C.) are disposed on the inner faces of lateral surfaces of the outer body 25 facing the ends of the wound electrode assembly 14 In the winding axis direction. The high-melting-point material 30 is provided for the following purpose for example, under conditions of a severe internal test such as a nail penetration test, when some factor causes thermal runaway of the prismatic nonaqueous electrolyte secondary battery 10 resulting in a high temperature gas being rapidly generated in large amounts in the battery, and the high temperature gas is discharged out from an end of the wound electrode assembly 14, the gas is discharged toward the high-melting-point material 30 so as to be unlikely to melt the outer body 25. On this account, the high-melting-point material 30 may be an insulating material or an electrically conductive material as long as it has a melting point of 700° C. or higher.

As the insulating material, one material selected form silicon dioxide, zirconia, alumina, titania, silicon carbide, silicon nitride, boron nitride, or similar substance, may be used. As the electrically conductive material, one material selected from scandium, titanium, vanadium, chromium, manganese, iron, cobalt, nickel, copper, yttrium, zirconium, niobium, molybdenum, ruthenium, rhodium, palladium, silver, hafnium, tantalum, tungsten, rhenium, osmium, iridium, platinum, gold, a titanium alloy, a stainless steel, a nickel alloy, a copper alloy, silicon, and carbon fiber may be used.

The high-melting-point material 30 preferably has a thickness from 0.05 mm to 0.5 mm and more preferably 0.1 to 0.5 mm. An appropriate thickness of the high-melting-point material 30 varies depending on the specific heat and the melting point of the high-melting-point material 30. When the high-melting-point material 30 has a thickness of less than 0.05 mm, the thickness of the high-melting-point material 30 is so small that heat of a high temperature gas generated in a battery will be directly conducted to the outer body 25, and the possibility of melting the outer body 25 will increase. When the high-melting-point material 30 has a thickness of more than 0.5 mm, the volume for the wound electrode assembly 14 will decrease proportionally, resulting in a reduction in the battery energy density.

The direct belching of a high temperature gas toward areas without the high-melting-point material 30 increases the possibility of melting of the outer body from the areas. To address this, the high-melting-point material 30 preferably covers the whole lateral face perpendicular to the winding axis direction of the wound electrode assembly 14 and further covers a broader area.

Next, as shown in FIG. 2 and FIG. 3, the wound electrode assembly 14 attached with the positive electrode collector 17 and the negative electrode collector 19 Is inserted into the prismatic outer body 25 while disposing the high-melting-point material 30 between the insulating sheet 24 and the outer body 25. Subsequently the sealing plate 23 is laser-welded to the mouth portion of the outer body 25, then a nonaqueous electrolytic solution is poured from the electrolyte pour hole 26, and the electrolyte pour hole 26 is sealed up to complete the prismatic nonaqueous electrolyte secondary battery 10 of the embodiment.

In the prismatic nonaqueous electrolyte secondary battery 10 of the embodiment, when some factor causes thermal runaway of the battery resulting in a high temperature gas being rapidly generated In the battery in large amounts, and the high temperature gas is discharged out from an end of the wound electrode assembly 14, the high temperature gas is discharged toward the high-melting-point material 30 having a higher melting point than the melting point of a material constituting the outer body 25. Thus, the high temperature gas generated in the battery is exhausted through a predetermined passage from the gas release valve 27 provided on the sealing plate 23 and hence the high temperature gas is not exhausted in any direction different from the intended direction. Therefore, the prismatic nonaqueous electrolyte secondary battery 10 having high reliability can be obtained.

When a plate made of the high-melting-point material 30 has a larger area than the area of the section perpendicular to the winding axis direction of the wound electrode assembly 14 and has a smaller area than the area of the lateral face of the outer body 25 facing the high-melting-point material 30, the plate made of the high-melting-point material 30 can sufficiently cover the end face of the electrode assembly. Hence, a high temperature gas is not directly discharged toward the outer body 25 and consequently the prismatic nonaqueous electrolyte secondary battery 10 having high reliability can be easily obtained. Furthermore, the outer body 25 electrically connected neither to the positive electrode sheet nor to the negative electrode sheet and having no polarity is unlikely to be corroded. Therefore, the prismatic secondary battery 10 having excellent, long-term durability and high long-term reliability can be obtained.

The invention suitably provides the advantages when the invention is applied to a prismatic nonaqueous electrolyte secondary battery having at least a large battery capacity of 20 Ah or more. The reason Is that a prismatic nonaqueous electrolyte secondary battery having a small battery capacity generates a high temperature gas in small amounts and such a gas is unlikely to melt the outer body even when a severe internal short circuit test such as a nail penetration test is carried out.

### EXAMPLE AND COMPARATIVE EXAMPLE

For confirming the advantages of the invention, a prismatic secondary battery corresponding to Example and a prismatic secondary battery corresponding to Comparative Example were produced as shown below and were subjected to the nail penetration test. First, in a similar manner to a related-art prismatic nonaqueous electrolyte secondary battery, a positive electrode active material mixture 11a was applied to an aluminum substrate, then the coated substrate was dried and rolled, and the substrate was slit so as to expose a strip-shaped aluminum foil to prepare a positive electrode sheet 11 used commonly in Example and Comparative Example, while a negative electrode active material mixture 12a was applied to a copper substrate, then the coated substrate was dried and rolled, and the substrate was slit so as to expose a strip-shaped copper foil to prepare a negative electrode sheet 12 used commonly in Example and Comparative Example. Here, lithium cobalt oxide was used as the positive electrode active material and graphite was used as the negative electrode active material,

The positive electrode sheet 11 and the negative electrode sheet 12 obtained as mentioned above were stacked with a microporous polyolefin separator 13 interposed therebetween so as to displace the positive electrode substrate exposed portion 15 made of the aluminum foil and the negative electrode substrate exposed portion 16 made of the copper foil from the counter electrode active material mixtures 12a and 11a, respectively, as shown in FIG. 1. The whole was wound to form a cylindrical-shaped electrode group including one end having a plurality of positive electrode substrate exposed portions 15 and including the other end having a plurality of negative electrode substrate exposed portions 16. Then, the cylindrical-shaped electrode group was pressed to prepare a flat wound electrode assembly 14. In the wound electrode assembly 14, the lateral face perpendicular to the winding axis direction had a size of about 23 mm×82 mm.

Next, the plurality of stacked positive electrode substrate exposed portions 15 were connected to a positive electrode terminal 18 through a positive electrode collector 17, while the plurality of stacked negative electrode substrate exposed portions 16 were similarly connected to a negative electrode terminal 20 through a negative electrode collector 19. The positive electrode terminal 18 and the negative electrode terminal 20 were fixed to a sealing plate 23 with insulating members 21 and 22 interposed therebetween, respectively.

The flat, wound electrode assembly 14 prepared as mentioned above was covered with an insulating sheet 24. Copper plates (85 mm×25 mm×0.2 mm) as the high-melting-point material were fixed with tape to the insulating sheet (the outer side of the insulating sheet) on both faces of the positive electrode sheet 11 site and the negative electrode sheet 12 site so as to be in contact with the lateral faces of an outer body 25. The whole was then inserted into the outer body 25, and a sealing plate 23 was laser-welded to the mouth portion of the outer body 25. Subsequently, a nonaqueous electrolytic solution was poured from an electrolyte pour hole 26, and the electrolyte pour hole 26 was sealing up to produce the prismatic nonaqueous electrolyte secondary battery 10 corresponding to Example.

The prismatic secondary battery of Comparative Example was produced by covering the wound electrode assembly prepared in a similar manner to that in Example with an insulating sheet, inserting the wrapped electrode assembly without the high-melting-point material into an outer body, laser-welding a sealing plate to a mouth portion of the outer body, then pouring a nonaqueous electrolytic solution form an electrolyte pour hole, and sealing up the electrolyte pour hole.

Next, a nail penetration test was carried out at room temperature as the test simulating the internal short circuit of a fully charged battery (charging condition: a battery was charged at a constant current of 1 It=25 A until the battery voltage reached 4.1 V and then was kept at a constant voltage of 4.1 V for an hour and a half to complete the charging). A nail having a diameter of 3 mm was used, each prismatic secondary battery of Example and Comparative Example was held at a constant thickness of 26.5 mm, then the nail was penetrated at the center of a long side surface of the battery at a speed of 80 mm/min, and the appearance after the penetration was observed. Each used prismatic secondary battery of Example and Comparative Example had a discharging capacity of 25.1 Ah at ⅓ C discharge and had a volumetric energy density of 253.6 Wh/L. The results are shown in Table 1.

TABLE 1

| | High-melting-point | |
|---|---|---|
| | material | Test result |
| Example | With copper plate | ◯ (cell side surface was not |
| | | cleaved) |
| Comparative | Without copper plate | X (cell side surface was cleaved) |
| Example | | |

From these results, the prismatic secondary battery of the invention can suppress gas exhaust in any unintended direction due to the cleavage of the outer body at the time of an internal short circuit of the battery. This enables easy design of a gas duct when a large number of prismatic secondary batteries are connected in series or parallel to form a module. Therefore, a prismatic secondary battery capable of improving the reliability as a module can be provided.

What is claimed is:

1. A prismatic secondary battery comprising:
a wound electrode assembly formed by winding a positive electrode sheet and a negative electrode sheet with a separator interposed therebetween;
a bottomed prismatic hollow outer body having a mouth and storing the wound electrode assembly; and
a sealing plate including a gas release valve and sealing up the mouth,
the wound electrode assembly being disposed in the outer body so that the winding axis direction of the wound electrode assembly is parallel to the bottom face of the outer body, and
a high-melting-point material having a higher melting point than the melting point of a material constituting the outer body being disposed between at least one of both ends of the wound electrode assembly in the winding axis direction and a lateral face of the outer body facing the end of the wound electrode assembly in the winding axis direction.

2. The prismatic secondary battery according to claim 1, wherein the high-melting-point material covers an area of 100% or more of a lateral face perpendicular to the winding axis direction of the wound electrode assembly in the outer body.

3. The prismatic secondary battery according to claim 1, wherein the high-melting-point material is a plate, has an larger area than a section area perpendicular to the winding axis direction of the wound electrode assembly, and has a smaller area than the area of the lateral face of the outer body facing the high-melting-point material.

4. The prismatic secondary battery according to claim 1, wherein the outer body has no polarity.

5. The prismatic secondary battery according to claim 1, wherein
the wound electrode assembly includes a stacked positive electrode substrate exposed portion on one end in the winding axis direction and includes a stacked negative electrode substrate exposed portion on the other end in the winding axis direction, and
a positive electrode collector is connected to an outermost surface of the stacked positive electrode substrate exposed portion in the stacking direction, and a negative electrode collector is connected to an outermost surface of the stacked negative electrode substrate exposed portion in the stacking direction.

6. The prismatic secondary battery according to claim 1, wherein
the bottomed prismatic hollow outer body is formed of aluminum or an aluminum alloy, and
the high-melting-point material has a melting point of 700° C. or higher.

7. The prismatic secondary battery according to claim 6, wherein the high-melting-point material is one material selected from silicon dioxide, zirconia, alumina, titania, silicon, carbide, silicon nitride, and boron nitride.

8. The prismatic secondary battery according to claim 6, wherein the high-melting-point material is one material selected from scandium, titanium, vanadium, chromium, manganese, iron, cobalt, nickel, copper, yttrium, zirconium, niobium, molybdenum, ruthenium, rhodium, palladium, silver, hafnium, tantalum, tungsten, rhenium, osmium, iridium, platinum, gold, a titanium alloy, a stainless steel, a nickel alloy, a copper alloy, silicon, and carbon fiber.

9. The prismatic secondary battery according to claim 8, wherein the high-melting-point material is electrically insulated from the positive electrode sheet and the negative electrode sheet.

10. The prismatic secondary battery according to claim 9, wherein an insulating sheet is disposed between the wound electrode assembly and the outer body, and the high-melting-point material Is disposed between the outer body and the insulating sheet.

11. The prismatic secondary battery according to claim 1, wherein the high-melting-point material has a thickness of from 0.05 mm to 0.5 mm.

12. The prismatic secondary battery according to claim 1, wherein the prismatic secondary battery has a battery capacity of 20 Ah or more.

13. The prismatic secondary battery according to claim 12, wherein
at least one of the positive electrode substrate exposed portion and the negative electrode substrate exposed portion is divided into two portions, and an intermediate member made of a resin material and having at least one conductive intermediate member is disposed between the two portions,
the collector close to the bisectional substrate exposed portion is disposed on at least one side of an outermost surface of the bisectional substrate exposed portion, and
the collector is electrically connected to the bisectional substrate exposed portion together with the at least one conductive intermediate member of the intermediate member by resistance welding.
